(19) United States
(12) Patent Application Publication
(10) Pub. No.: US 2020/0280815 A1
(43) Pub. Date: Sep. 3, 2020

(54) AUDIO SIGNAL PROCESSING DEVICE AND AUDIO SIGNAL PROCESSING SYSTEM

(71) Applicant: SHARP KABUSHIKI KAISHA, Sakai City, Osaka (JP)

(72) Inventors: TAKEAKI SUENAGA, Sakai City, Osaka (JP); HISAO HATTORI, Sakai City, Osaka (JP)

(21) Appl. No.: 16/645,455

(22) PCT Filed: Apr. 5, 2018
(86) PCT No.: PCT/JP2018/014536

§ 371 Date: Mar. 6, 2020

(30) Foreign Application Priority Data
Sep. 11, 2017 (JP) 2017-174102

(51) Int. Cl. H04S 7/00

(52) U.S. Cl. CPC H04S 7/303

(57) ABSTRACT

An aspect of the present invention includes an audio signal renderer rendering an audio signal input, and outputting the rendered audio signal to one or more audio signal output units based on position information obtained by a viewer position information obtainment unit, the one or more audio signal output units including a first audio signal output unit an audible region of which does not move and a second audio signal output unit an audible region of which moves.

### TECHNICAL FIELD

The present invention relates to an audio signal processing device and an audio signal processing system.

### BACKGROUND ART

Through broadcast waves, disc media such as a digital versatile disc (DVD) and a Blue-ray (a registered trade mark) disc (BD), or the Internet, recent users can easily obtain content including multi-channel audio (surround audio). For example, many movie theaters introduce stereophonic systems utilizing object-based audio as typified by Dolby Atmos. Furthermore, in Japan, the 22.2-ch audio is adopted as the next-generation broadcast format, such that the users have ample opportunities to view multi-channel content. Various studies are conducted to devise techniques to process a conventional stereo audio signal to have multiple channels. Patent Document 1 discloses a technique to provide multiple channels based on a correlation between the channels of a stereo signal.

Of the systems to reproduce multi-channel audio, systems becoming common are the ones easily available for home-use, other than such facilities as the movie theaters or halls provided with large audio equipment. A user can arrange multiple speakers based on an arrangement standard recommended by the International Telecommunication Union (ITU) to create a home environment to listen to multi-channel audio such as 5.1 or 7.1 multi-channel audio. Moreover, studies are also conducted to devise techniques to localize a multi-channel sound image with a small number of speakers (see Non-Patent Document 1).

### CITATION LIST

### Patent Literature

[Patent Document 1] Japanese Unexamined Patent Application Publication No. 2013-055439
[Patent Document 2] Japanese Unexamined Patent Application Publication (Translation of PCT Application) No. H10-500809
[Patent Document 3] Japanese Unexamined Patent Application Publication (Translation of PCT Application) No. 2012-505575
[Patent Document 4] WO15/068756

### Non-Patent Literature

[Non-Patent Document] Virtual Sound Source Positioning Using Vector Base Amplitude Panning. VILLE PULKKI, J. Audio. Eng., Vol. 45, No. 6, 1997 June

### SUMMARY OF INVENTION

### Technical Problem

As described above, when the speakers are arranged based on the arrangement standard recommended by the ITU, a system to reproduce 5.1-channel audio can make a user feel that a sound image around him or her is localized and the user is surrounded with the sound. On the other hand, the speakers are desired to be arranged around the user, and the mutual distance between the speakers and the user have to be maintained constant. Accordingly, a sweet spot; that is, a region available for the user to watch and listen to content while he or she enjoys the advantageous effects of the multi-channel is ideally limited to one region. When many people view the content, it is difficult to for all of the viewers to obtain the same advantageous effects. In addition, viewers out of the sweet spot might have an effect different from the advantageous effects that can be originally enjoyed in the sweet spot (e.g., the audio supposed to be localized to the left of a viewer is actually localized to the right).

Studies are also conducted to devise techniques to reproduce multi-channel audio with earphones or headphones. Patent Documents 2 and 3 disclose a technique to utilize the binaural reproduction to virtually reproduce multi-channel audio in a prospective reproduction position. However, the binaural reproduction has difficulty in presenting sound spreading in accordance with a viewing environment; that is, for example, sound spreading in accordance with the size of a viewing environment.

Hence, an aspect of the present invention intends to provide an audio signal processing device and audio signal processing system capable of offering a high-quality sound field to a user.

### Solution to Problem

In order to solve the above problems, an audio signal processing device for multiple channels according to an aspect of the present invention includes: a sound image localization information obtainment unit obtaining information indicating whether an audio signal input is subjected to sound image localization; and a renderer rendering the audio signal input, and outputting the rendered audio signal to one or more audio signal output units based on the information, the one or more audio signal output units including a first audio signal output unit an audible region of which does not move while a user is listening to audio and a second audio signal output unit an audible region of which moves while the user is listening to the audio.

Moreover, in order to solve the above problems, another audio signal processing device for multiple channels according to an aspect of the present invention includes: a position information obtainment unit obtaining position information on a user; and a renderer rendering an audio signal input, and outputting the rendered audio signal to one or more audio signal output units based on the position information, the one or more audio signal output units including a first audio signal output unit an audible region of which does not move while the user is listening to audio and a second audio signal output unit an audible region of which moves while the user is listening to the audio.

Furthermore, in order to solve the above problems, an audio signal processing system for multiple channels includes: a first audio signal output unit an audible region of which does not move while a user is listening to audio and a second audio signal output unit an audible region of which moves while the user is listening to the audio; a sound image localization information obtainment unit obtaining information indicating whether an audio signal input is subjected to sound image localization; and a renderer rendering the audio signal input, and outputting the rendered audio signal to one or more audio signal output units based on the information, the one or more audio signal output units including the first audio signal output unit and the second audio signal output unit.

Moreover, in order to solve the above problems, an audio signal processing system for multiple channels includes: a first audio signal output unit an audible region of which does not move while a user is listening to audio and a second audio signal output unit an audible region of which moves while the user is listening to the audio; a position information obtainment unit obtaining position information on a user; and a renderer rendering an audio signal input, and outputting the rendered audio signal to one or more audio signal output units based on the position information, the one or more audio signal output units including the first audio signal output unit and the second audio signal output unit.

### Advantageous Effects of Invention

An aspect of the present invention can offer a high-quality sound field to a user.

### BRIEF DESCRIPTION OF DRAWINGS

FIG. 1 is a block diagram illustrating a main configuration of an audio signal processing system according to an embodiment of the present invention.

FIG. 2 is a drawing schematically illustrating a configuration of track information including sounding object position information to be obtained through analysis by a content analyzer included in the audio signal processing system according to the embodiment of the present invention.

FIG. 3 is a diagram illustrating a coordinate system of a position of a sound image recorded as a part of the sounding object position information illustrated in FIG. 2.

FIG. 4 is a flowchart explaining a flow of rendering performed by an audio signal renderer included in the audio signal processing system according to the embodiment of the present invention.

FIG. 5 is a top view schematically illustrating positions of a user.

FIG. 6 is a block diagram illustrating a main configuration of an audio signal processing system according to another embodiment of the present invention.

FIG. 7 is a block diagram illustrating a main configuration of an audio signal processing system according to still another embodiment of the present invention.

FIG. 8 is a flowchart explaining a flow of rendering performed by an audio signal renderer included in the audio signal processing system according to the still other embodiment of the present invention.

FIG. 9 is a top view schematically illustrating positions of a user.

FIG. 10 is a top view illustrating a positional relationship between a user and speakers as to the audio signal processing system according to still another embodiment of the present invention.

FIG. 11 is a top view illustrating a positional relationship between a user and speakers as to the audio signal processing system according to the still other embodiment of the present invention.

FIG. 12 is a top view schematically illustrating positions of users.

### DESCRIPTION OF EMBODIMENTS

### First Embodiment

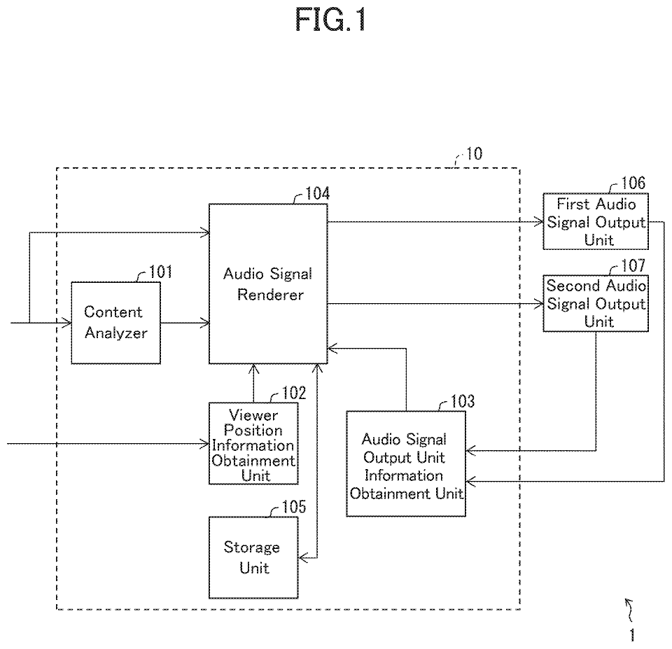

Described below is an embodiment of the present invention with reference to FIGS. 1 to 5.

FIG. 1 is a block diagram illustrating a main configuration of an audio signal processing system 1 according to a first embodiment. The audio signal processing system 1 according to the first embodiment includes: a first audio signal output unit 106; a second audio signal output unit 107; and an audio signal processor 10 (an audio signal processing device).

<First Audio Signal Output Unit 106 and Second Audio Signal Output Unit 107>

Both the first audio signal output unit 106 and the second audio signal output unit 107 obtain an audio signal reconstructed by the audio signal processor 10 to reproduce audio.

The first audio signal output unit 106 includes a plurality of stationary independent speakers. Each of the speakers includes a speaker unit and an amplifier to drive the speaker unit. The first audio signal output unit 106 is an audio signal output device whose audible region does not move while the user is listening to the audio. The audio signal output device whose audible region does not move while the user is listening to the audio is directed to a device to be used with the position of the audible region staying still while the user is listening to the audio. When the user is not listening to the audio (for example, when the audio signal output device is installed), the position of the audible region of the audio signal output device may be moved; that is, the audio signal output device may be moved. Moreover, the position of the audible region of the audio signal output device may be kept from moving when the user is not listening to the audio.

The second audio signal output unit 107 (a portable speaker for the user) includes: open-type headphones or earphones; and an amplifier to drive the open-type headphones or earphones. The second audio signal output unit 107 is an audio signal output device an audible region of which can move while the user is listening to the audio. The audio signal output device an audible region of which can move while the user is listening to the audio is directed to a device to be used with the position of the audible region moving while the user is listening to the audio. For example, the audio signal output device may be a portable audio signal output device so that the audio signal output device per se may move together with the user while he or she is listening to the audio, and, in association with the movement, the position of the audible region moves. Furthermore, while the user is listening to the audio, the audio signal output device may be capable of moving the audible region while the audio signal output device per se does not move.

Furthermore, as described later, an exemplary technique to obtain a position of the viewer involves providing the second audio signal output unit 107 with a position information transmission device, and obtaining the position information. The position information may be obtained, using beacons placed in any given several positions in the viewing environment, and a beacon provided to the second audio signal output unit 107.

Note that the first audio signal output unit 106 and the second audio signal output unit 107 do not have to be limited to the above combination. As a matter of course, for example, the first audio signal output unit 106 may be a monaural speaker or a 5.1-channel surround speaker set. Moreover, the second audio signal output unit 107 may be a small-sized speaker placed in hand of the user or a handheld device typified by a smartphone and a tablet. In addition, the number of the audio signal output units to be connected is not limited to two. Alternatively, the number may be larger than two.

<Audio Signal Processor 10>

The audio signal processor 10, working as a multi-channel audio signal processing device, reconstructs an audio signal input, and outputs the reconstructed audio signal to the first audio signal output unit 106 and the second audio signal output unit 107.

As illustrated in FIG. 1, the audio signal processor 10 includes: a content analyzer 101 (an analyzer); a viewer position information obtainment unit 102 (a position information obtainment unit); an audio signal output unit information obtainment unit 103 (an audio signal output unit information obtainment unit); and an audio signal renderer 104 (an sound image localization information obtainment unit and a renderer); and a storage unit 105.

Described below is a configuration of each of the features in the audio signal processor 10.

<Content Analyzer 101>

The content analyzer 101 analyzes: an audio signal included in video content or audio content stored in disc media such as a DVD and a BD and storage media such as a hard disc drive (HDD); and metadata accompanying the audio signal. Then, the content analyzer 101 analyzes the audio signal and the metadata to obtain sounding object position information (a kind of an audio signal (an audio track) included in the audio content, and position information in which the audio signal localizes). The obtained sounding object position information is output to the audio signal renderer 104.

In the first embodiment, the audio content to be received by the content analyzer 101 is to include one or more audio tracks.

(Audio Track)

Here, this audio track is classified into two broad categories. One example of the category includes a “channel-based” audio track adopted for such channels as stereo (a 2 channel) and a 5.1 channel and associating a predetermined position of a speaker with the audio track. The other example of the category includes an “object-based” audio track in which an individual sounding object unit is set as one track. The “object-based” audio track is provided with accompanying information on a change in position and audio volume of the one track.

Described below is a concept of the “object-based” audio track. The object-based audio track is created as follows: sounding objects are stored on subject-by-subject basis in the tracks; that is, the sounding objects are stored unmixed. The sounding objects are appropriately rendered in a player (a reproducer). Despite the differences among the standards and formats, these sounding objects are each associated typically with metadata (accompanying information) on sound to be provided when, where, and what volume level. Based on the metadata, the player render each of the sounding objects.

Meanwhile, the “channel-based track” is adopted for conventional surround, such as 5.1 surround. Moreover, the channel-based track is stored while each of the sounding objects is mixed as a precondition that sound is provided from a predetermined reproduction position (a position of a speaker).

Audio tracks to be included in one content item may be included in either one of the two categories alone. Alternatively, two categories of audio tracks may be mixed in the content item.

(Sounding Object Position Information)

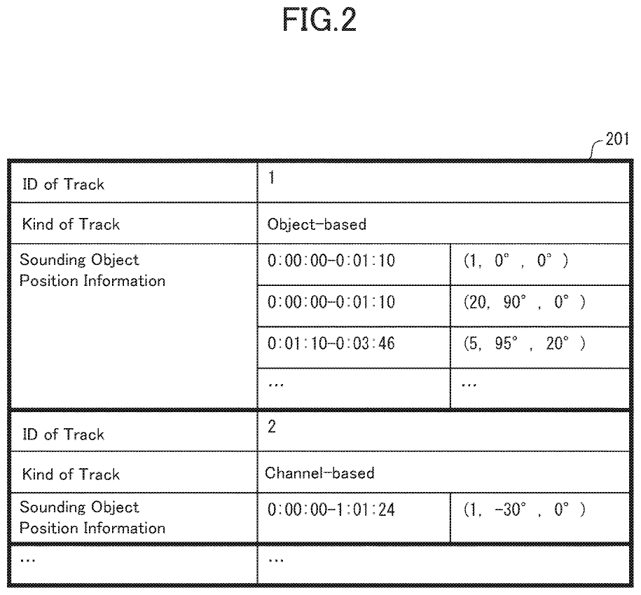

Described below is the sounding object position information with reference to FIG. 2.

FIG. 2 is a drawing schematically illustrating a configuration of track information 201 including the sounding object position information to be obtained through analysis by the content analyzer 101.

The content analyzer 101 analyzes all the audio tracks included in a content item, and reconstruct the audio tracks into the track information 201 illustrated in FIG. 2.

The track information 201 stores an ID of each audio track and a kind of the audio track.

When the audio track is object-based, the track information 201 is further provided with one or more sounding object position information items as metadata. The sounding object position information item includes a pair of a reproduction time and a sound image position at the reproduction time.

On the other hand, when the audio track is channel-based, the track information 201 also includes a pair of a reproduction time and a sound image position at the reproduction time. Note that if the audio track is channel-based, the reproduction time represents a time period between the start and the end of the content. Moreover, the sound image position at the reproduction time is based on a reproduction position previously defined by the channel base.

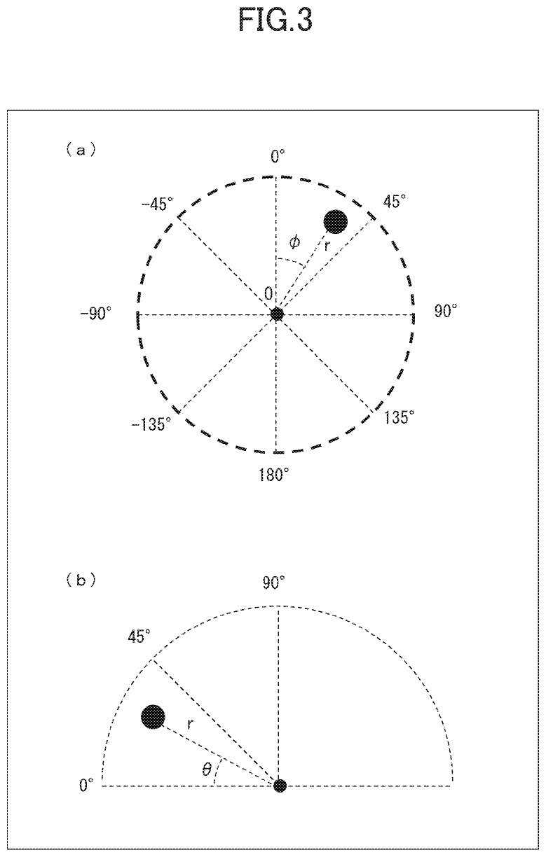

Here, the sound image position stored as a part of the sounding object position information is to be represented by the coordinate system illustrated in FIG. 3. As seen in the top view in the illustration (a) in FIG. 3, the coordinate system here is to have the origin O as the center, and to represent the distance from the origin O by a moving radius r. Moreover, the coordinate system is to represent an argument φ with the front of the origin O determined as 0°, the right and the left each determined as 90°. As seen in the side view in the illustration (b) of FIG. 3, the coordinate system is to represent an elevation angle θ with the front of the origin O determined as 0°, and the position directly above the origin O determined as 90°. Furthermore, the coordinate system is to denote positions of a sound image and a speaker by a polar coordinate (spherical coordinate) system (r, φ, θ). In the explanations below, the positions of a sound image and a speaker are to be represented by the polar coordinate system in FIG. 3, unless otherwise specified.

The track information 201 is described in such markup language as the Extensible Markup Language (XML).

In this first embodiment, of the information to be obtained by analyzing audio tracks and metadata accompanying the audio tracks, the only information to be stored as the track information is the one with which the position information of each sounding object is specified at any given time. As a matter of course, however, the track information may include information other than such information.

[Viewer Position Information Obtainment Unit 102]

The viewer position information obtainment unit 102 obtains position information on a user viewing content. Note that assumed in the first embodiment is to view such content as a DVD. Hence, the user is to view the content. However, a feature of the present invention is directed to audio signal processing. From this viewpoint, the user may at least listen to the content; that is, the user may be a listener.

In the first embodiment, the viewer position information is to be obtained and updated in real time. In this case, for example, not-shown one or more cameras (imaging devices) are placed in any given position (e.g., a room ceiling) in the viewing environment and connected to the viewer position information obtainment unit 102. The cameras capture a user having a previously attached marker. Moreover, the viewer position information obtainment unit 102 is to obtain a two-dimensional or a three-dimensional position of the viewer based on the data captured with the cameras, and update the viewer position information. The marker may be attached to the user himself or herself, or to an item which the user wears, such as the second audio signal output unit 107.

Another technique to obtain the viewer position may be to utilize facial recognition based on the position information of the user to be obtained from the image data of the placed cameras (the imaging devices).

Still another technique to obtain the viewer position may be to provide the second audio signal output unit 107 with a position information transmission device to obtain the information on the position. Moreover, the position information may be obtained, using beacons placed in any given several positions in the viewing environment, and a beacon provided to the second audio signal output unit 107. Furthermore, the information may be input in real time through such an information input terminal as a tablet terminal.

[Audio Signal Output Unit Information Obtainment Unit 103]

The audio signal output unit information obtainment unit 103 obtains information on the first audio signal output unit 106 and the second audio signal output unit 107 both connected to the audio signal processor 10. Hereinafter, the information may collectively be referred to as “audio signal output unit information.”

In this Description, the “audio signal output unit information” indicates type information and information on the details of the configuration of an audio signal output unit. The type information indicates whether an audio output unit (an audio output device) is of a stationary type such as a speaker or of a wearable type such as earphones. Moreover, the information on the details of the configuration of an audio signal output unit indicates, for example, the number of the audio signal output units if the units are speakers, and the type of the audio signal output units; that is, whether the open-type units or the sound-isolating-type units if the units are headphones and earphones. Here, as to the open-type headphones or earphones, a component of the headphones or the earphones is kept from blocking an ear canal and an eardrum from outside, such that a wearer of the headphones or the earphones hears external sound. Meanwhile, as to the sound-isolating-type headphones or earphones, a component of the headphones or the earphones blocks an ear canal and an eardrum from outside, such that a wearer of the headphones or the earphones cannot hear or is less likely to hear external sound. In the first embodiment, the second audio signal output unit 107 is open-type headphones or earphones to allow the wearer of the headphones or the earphones to hear external sound as described above. However, if the sound-isolating headphones or earphones can pick up surrounding sound with an internal microphone and allow the wearer to hear the surrounding sound together with the audio output from the headphones or earphones, such sound-isolating headphones or earphones may be adopted.

Such information is previously stored in the first audio signal output unit 106 and the second audio signal output unit 107. The audio signal output unit information obtainment unit 103 obtains the information by wire or wireless communications such as Bluetooth (a registered trade mark) and Wi-Fi (a registered trade mark).

Note that the information may automatically be transmitted from the first audio signal output unit 106 and the second audio signal output unit 107 to the audio signal output unit information obtainment unit 103. Furthermore, when the audio signal output unit information obtainment unit 103 obtains the information from the first audio signal output unit 106 and the second audio signal output unit 107, the audio signal output unit information obtainment unit 103 may have a pass to instruct first the first audio signal output unit 106 and the second audio signal output unit 107 to transmit the information.

Note that the audio signal output unit information obtainment unit 103 may obtain information other than the above information as information on the audio signal output units. For example, the audio signal output unit information obtainment unit 103 may obtain the position information and acoustic characteristic information on the audio signal output units. Moreover, the audio signal output unit information obtainment unit 103 may provide the acoustic characteristic information to the audio signal renderer 104, and the audio signal renderer 104 may adjust audio tone.

[Audio Signal Renderer 104]

The audio signal renderer 104 constructs an audio signal to be output to the first audio signal output unit 106 and the second audio signal output unit 107, based on the audio signal input to the audio signal renderer 104 and various kinds of information from the constituent features connected to the audio signal renderer 104; namely, the content analyzer 101, the viewer position information obtainment unit 102, the audio signal output unit information obtainment unit 103, and the storage unit 105.

<Rendering>

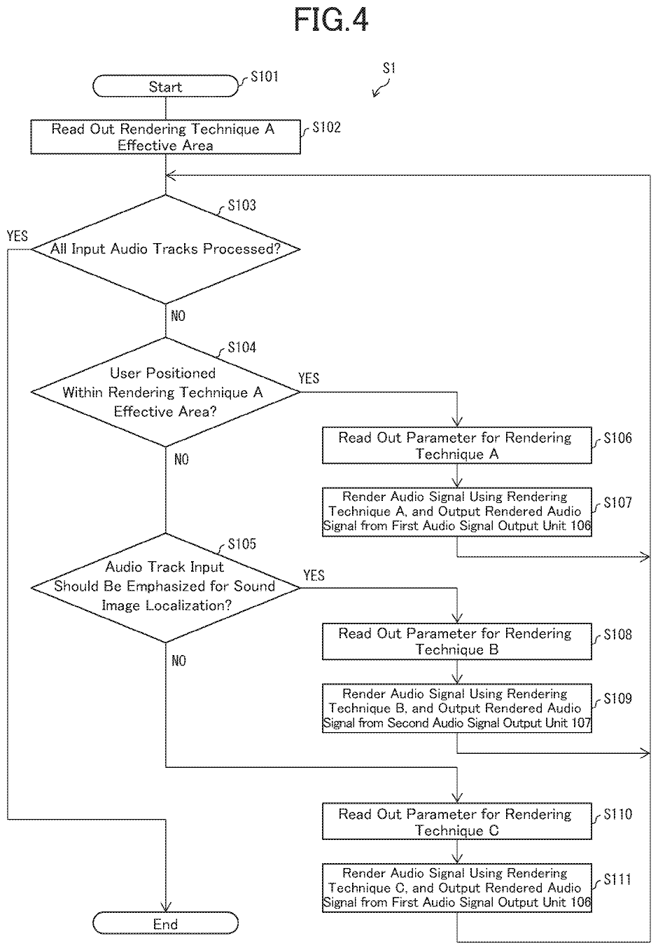

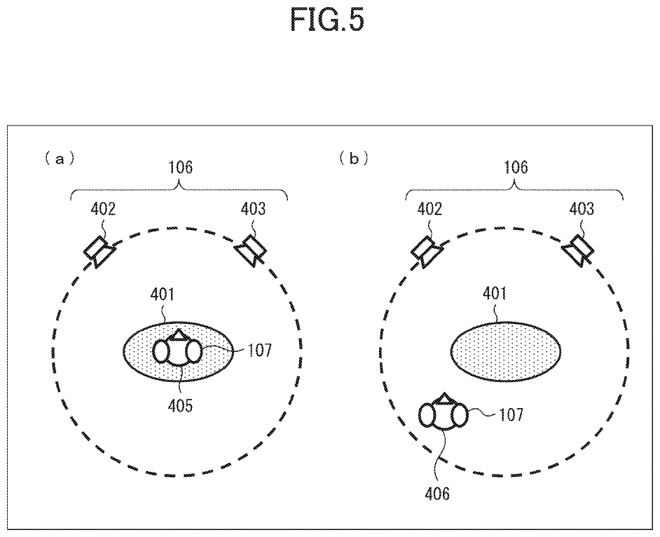

FIG. 4 is a flowchart S1 explaining a flow of rendering performed by the audio signal renderer 104. Described below is the rendering with reference to FIG. 4 and FIG. 5; that is, a top view schematically illustrating positions of a user.

As seen in FIG. 4, the audio signal renderer 104 starts processing (Step S101). First, the audio signal renderer 104 obtains from the storage unit 105 an area capable of providing an advantageous effect of the audio signal to be output with a basic rendering technique (hereinafter referred to as “rendering technique A”); that is, a rendering technique A effective area 401; namely, an audible region or a predetermined audible region (also referred to as a sweet spot) (Step S102). Moreover, in this step, the audio signal renderer 104 obtains from the audio signal output unit information obtainment unit 103 information on the first audio signal output unit 106 and the second audio signal output unit 107.

Next, the audio signal renderer 104 checks whether the processing is performed on all the input audio tracks (Step S103). If the processing after Step S104 completes on all the tracks (Step S103: YES), the processing ends (Step S112). If an unprocessed input audio track is found (Step S103: NO), the audio signal renderer 104 obtains from the viewer position information obtainment unit 102 viewing position information on a viewer (user).

Here, as illustrated in an illustration (a) in FIG. 5, if a viewing position 405 of the user is within the rendering technique A effective area 401 (Step S104: YES), the audio signal renderer 104 reads out from the storage unit 105 a parameter to be required for rendering an audio signal, using the rendering technique A (Step S106). Then, the audio signal renderer 104 renders the audio signal using the rendering technique A, and outputs the rendered audio signal to the first audio signal output unit 106 (Step S107). Note that, as described above, the first audio signal output unit 106 in this first embodiment includes stationary speakers. As seen in the illustration (a) in FIG. 5, the first audio signal output unit 106 includes two speakers; namely, a speaker 402 and a speaker 403 placed in front of the users. Specifically, the rendering technique A involves transaural processing using these two speakers. Note that, in this case, the second audio signal output unit 107 does not output audio.

Meanwhile, as seen in an illustration (b) in FIG. 5, a viewing position 406 of the user is to be out of the rendering technique A effective area 401. In this case (Step S104: NO), based on track kind information included in the sounding object position information obtained from the content analyzer 101, the audio signal renderer 104 determines whether an audio track input is subjected to sound image localization (Step S105). In this first embodiment, the audio track subjected to sound image localization is the object-based track in the track information 201 in FIG. 2. If the audio track input is subjected to sound image localization (Step S105: YES), the audio signal renderer 104 reads out from the storage unit 105 a parameter to be required for rendering an audio signal, using a rendering technique B (Step S108). Then, the audio signal renderer 104 renders the audio signal using the rendering technique B. and outputs the rendered audio signal to the second audio signal output unit 107 (Step S109). Note that, as described above, the second audio signal output unit 107 in this first embodiment is open-type headphones or earphones. The rendering technique B involves binaural processing, using these open-type headphones or earphones. Note that, in this case, the first audio signal output unit 106 (the two speakers 402 and 403) does not output audio.

Note that a head related transfer function (HRTF) to be used in the binaural reproduction may be a fixed value. Moreover, the HRTF may be updated depending of a viewing position of the user, and additionally processed so that an absolute position of a virtual sound image does not move regardless of the viewing position.

On the other hand, if the input audio track is not subjected to sound image localization (Step S105: NO), the audio signal renderer 104 reads out from the storage unit 105 a parameter to be required for rendering an audio signal, using a rendering technique C (Step S110). Then, the audio signal renderer 104 renders the audio signal using the rendering technique C, and outputs the rendered audio signal to the first audio signal output unit 106 (Step S111). As described above, the first audio signal output unit 106 in this first embodiment is the two speakers 402 and 403. The rendering technique C involves down-mixing the audio signal to stereo audio. When outputting the stereo audio, the two speakers 402 and 403 included in the first audio signal output unit 106 function as a pair of stereo speakers. Note that, in this case, the second audio signal output unit 107 does not output audio.

Applying the processing to all the audio tracks, the audio signal renderer 104 determines an audio signal output unit to output audio and switches a rendering technique to be used for rendering, depending on the position of the viewer; that is, whether the user is positioned in an effective area capable of providing the user with an advantageous effect of the rendering technique A. Such features make it possible to offer the user a sound field which can provide both a localized sound image and spreading sound no matter where the user is positioned.

Here, the rendering includes converting an audio signal (an input audio signal) included in the content into a signal to be output from at least one of the first audio signal output unit 106 and the second audio signal output unit 107.

Note that the audio tracks to be received at once by the audio signal renderer 104 may include all the data from the beginning to the end of the content. As a matter of course, the tracks may be divided into any given time of units, and the divided tracks may repeatedly receive the processing seen in the flow S1 by the units. Such configurations make it possible cope with the change in the position of the user in real time.

Moreover, the rendering techniques A to C are examples, and rendering techniques shall not be limited to the techniques A to C. In the description above, for example, the rendering technique A involves transaural rendering regardless of a kind of an audio track. Alternatively, the rendering technique A may involve changing a rendering technique depending on a kind of an audio track; that is, a channel-based track is down-mixed to stereo audio and an object-based track is to be transaural-rendered.

[Storage Unit 105]

The storage unit 105 is a secondary storage device for storing various kinds of data to be used by the audio signal renderer 104. Examples of the storage unit 105 include a magnetic disc, an optical disc, or a flash memory. More specific examples thereof include a hard disk drive (HDD), a solid state drive (SSD), a secure digital (SD) memory card, a Blu-ray disc (BD), and a digital versatile disc (DVD). The audio signal renderer 104 reads out data as necessity from the storage unit 105. Moreover, the storage unit 105 can also store various kinds of parameter data including coefficients calculated by the audio signal renderer 104.

As can be seen, in this first embodiment, depending on the viewing position of the user and the information from the content, a preferred rendering technique in view of both sound image localization and spreading sound is automatically selected for each of the audio tracks, and the audio is reproduced. Such features make it possible to provide the user with audio having less problems in sound localization and spreading sound no matter where the viewer is positioned.

[Modification]

Of the three features in this first embodiment; namely, the audio signal processor 10, the first audio signal output unit 106; and the second audio signal output unit 107, the audio signal processor 10 obtains information from the first audio signal output unit 106 and the second audio signal output unit 107. Moreover, in the first embodiment, the audio signal processor 10 analyzes an input audio signal, and render the audio signal based on the information from the first audio signal output unit 106 and the second audio signal output unit 107. That is, the audio signal processor 10 carries out a series of the above-mentioned audio signal processing.

However, the present invention shall not be limited to the above configurations. For example, the first audio signal output unit 106 and the second audio signal output unit 107 may detect their respective positions. Then, based on information indicating the detected positions and an input audio signal, the first audio signal output unit 106 and the second audio signal output unit 107 may analyze an audio signal to be output, render the input audio signal, and output the rendered audio signal.

That is, the audio signal processing operations of the audio signal processor 10 described in the first embodiment may be separately assigned to the first audio signal output unit 106 and the second audio signal output unit 107.

### Second Embodiment

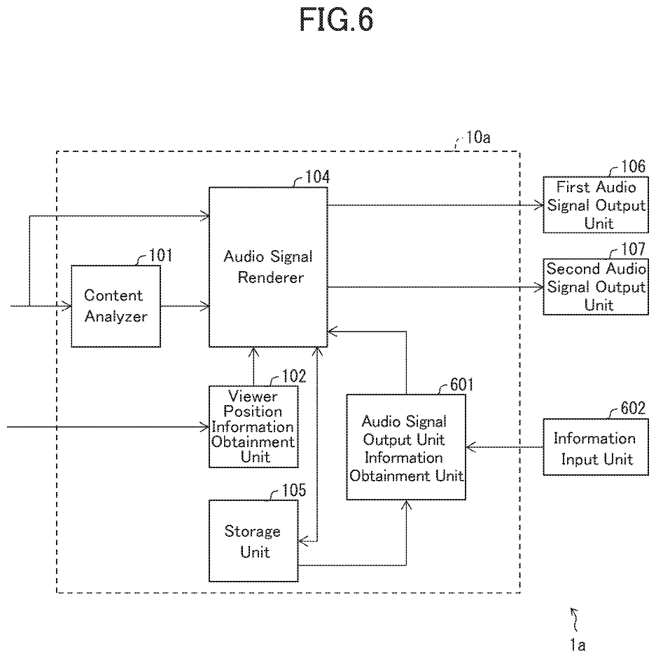

Described below is another embodiment of the audio signal processing system according to an aspect of the present invention, with reference to FIG. 6. Note that, for the sake of explanation, identical reference signs are used to denote components with identical functions between the first embodiment and this embodiment. Such components will not be elaborated upon here.

FIG. 6 is a block diagram illustrating a main configuration of an audio signal processing system 1a according to a second embodiment of the present invention.

This second embodiment is different from the first embodiment as to how an audio signal output unit information obtainment unit obtains information on an audio output unit. In other words, this second embodiment is different from the first embodiment in how to offer information on the audio output unit to the audio signal output unit information obtainment unit. That is, the difference between this second embodiment and the first embodiment is that, instead of the audio signal output unit information obtainment unit 103 illustrated in FIG. 1 of the first embodiment, the second embodiment features an audio signal processor 10a including an audio signal output unit information obtainment unit 601, and an information input unit 602 provided outside the audio signal processor 10a.

Specifically, the audio signal processor 10a according to the second embodiment is an audio signal processing device reconstructing an audio signal input, and reproducing the audio signal using two or more different kinds of audio signal output devices. As illustrated in FIG. 6, the audio signal processor 10a includes the content analyzer 101. The content analyzer 101: analyzes an audio signal included in video content or audio content stored in disc media such as a DVD and a BD and an HDD, and metadata accompanying the audio signal; and obtains a kind of the included audio signal and position information in which the audio signal localizes. Moreover, the audio signal processor 10a includes the viewer position information obtainment unit 102 obtaining position information on the viewer viewing the content. Furthermore, the audio signal processor 10a includes the audio signal output unit information obtainment unit 601. The audio signal output unit information obtainment unit 601 obtains from the storage unit 105 information on the first audio signal output unit 106 and the second audio signal output unit 107 provided outside and connected to the previously-identified audio signal processor 10a. In addition, the audio signal processor 10a receives an audio signal included in the video content and the audio content. Furthermore, the audio signal processor 10a includes the audio signal renderer 104. The audio signal renderer 104 renders and mixes an output audio signal based on the kind of audio and the position information obtained by the content analyzer 101, the viewer position information obtained by the viewer position information obtainment unit 102, and audio output device information obtained by the audio signal output unit information obtainment unit 601. Then, after the mixing, the audio signal renderer 104 outputs the mixed audio signal to the first audio signal output unit 106 and the second audio signal output unit 107 provided outside. Moreover, the audio signal processor 10a includes the storage unit 105 storing various parameters to be required for, or generated by, the audio signal renderer 104.

In this second embodiment, the audio signal output unit information obtainment unit 601 selects the information, on the first audio signal output unit 106 and the second audio signal output unit 107 to be connected to the audio signal processor 10a and provided outside, through an information input unit 602 from among multiple information items previously stored in the storage unit 105. Moreover, the information input unit 602 may directly input a value. Furthermore, when the first audio signal output unit 106 and the second audio signal output unit 107 are already identified and expected not to be changed, the storage unit 105 may store the information on the first audio signal output unit 106 and the second audio signal output unit 107 alone, and the audio signal output unit information obtainment unit 601 may read out the information alone.

Note that examples of the information input unit 602 include such wired or wireless devises as a keyboard, a mouse, and a track ball, and wired or wireless information terminals as a PC, a smartphone, and a tablet. As a matter of course, the second embodiment may include a not-shown device (such as a display) as necessity for presenting visual information to be required for the input of information.

Note that operations other than the above ones are the same as those described in the first embodiment, and the description thereof shall be omitted.

As can be seen, the information on the audio output units is obtained from the storage unit 105 or the external information input unit 602. Such a configuration makes it possible to achieve the advantageous effects described in the first embodiment, even if the first audio signal output unit 106 and the second audio signal output unit 107 cannot notify the audio signal processor 10a of their respective information items.

### Third Embodiment

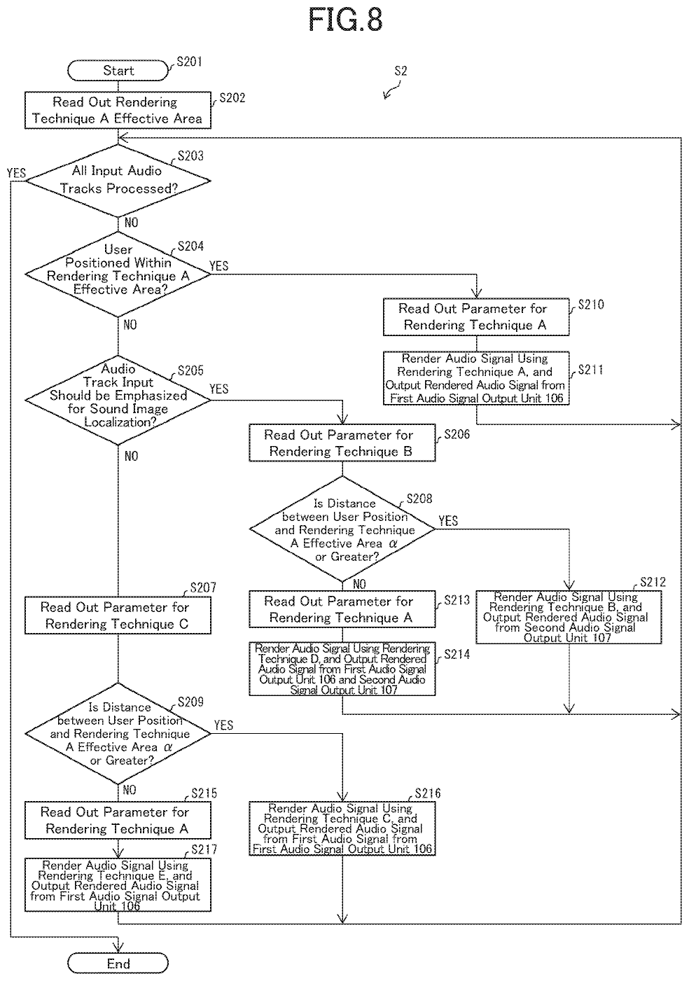

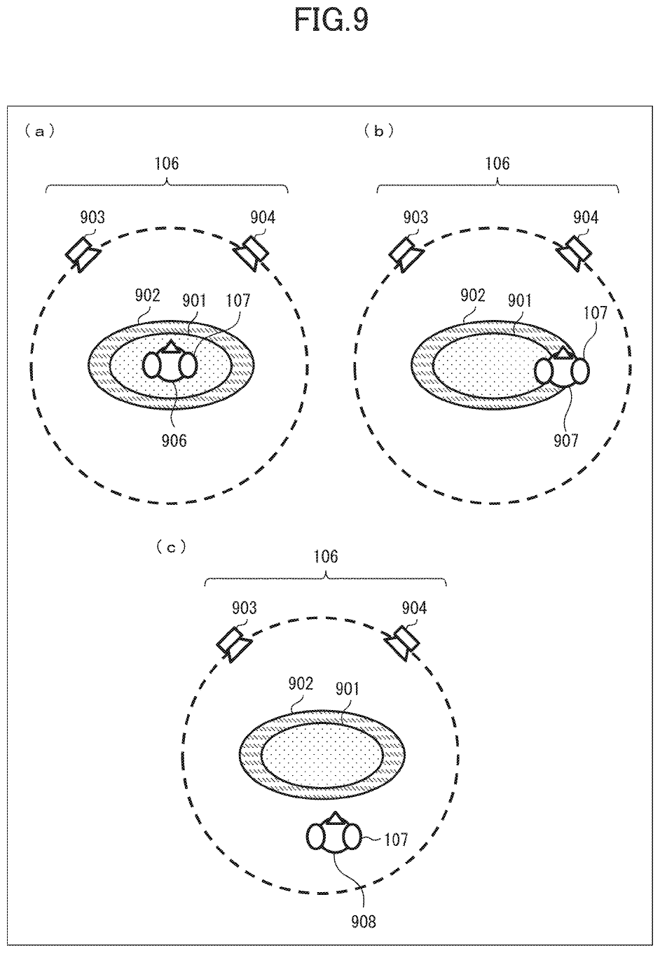

Described below is still another embodiment of the audio signal processing system according to an aspect of the present invention, with reference to FIGS. 8 and 9. Note that, for the sake of explanation, identical reference signs are used to denote components with identical functions between the first embodiment and this embodiment. Such components will not be elaborated upon here.

This third embodiment is different only in operation of an audio signal renderer from the first embodiment. Note that operations other than the above one are the same as those described in the first embodiment, and the description thereof shall be omitted.

The processing performed by the audio signal renderer 104 of this third embodiment is different from that of the first embodiment as follows: as seen in the top views of FIG. 9 schematically illustrating positions of a user, the former processing includes processing in an effective area 901 for the rendering technique A, and further includes processing in an area 902 positioned at a constant distance from the effective area 901.

FIG. 8 illustrates is a flowchart S2 explaining a flow of rendering performed by the audio signal renderer 104. Described below is the rendering with reference to FIGS. 8 and 9.

The audio signal renderer 104 starts processing (Step S201). First, the audio signal renderer 104 obtains from the storage unit 105 an area capable of providing an advantageous effect of an audio signal to be output with the rendering technique A; that is, a rendering technique A effective area 901 (Step S202). Next, the audio signal renderer 104 checks whether the processing is performed on all the input audio tracks (Step S203). If the processing after Step S204 completes for all the tracks (Step S203: YES), the processing ends (Step S218). If an unprocessed input audio track is found (Step S203: NO), the audio signal renderer 104 obtains from the viewer position information obtainment unit 102 viewing position information. Here, as illustrated in an illustration (a) in FIG. 9, if a viewing position 906 of the user is within the rendering technique A effective area 901 (Step S204: YES), the audio signal renderer 104 reads out from the storage unit 105 a parameter to be required for rendering an audio signal, using the rendering technique A (Step S210). Then, the audio signal renderer 104 renders the audio signal using the rendering technique A, and outputs the rendered audio signal to the first audio signal output unit 106 (Step S211). Note that, in this embodiment, the first audio signal output unit 106 includes two speakers 903 and 904 arranged in front of the user as illustrated in FIG. 9. The rendering technique A involves transaural processing using these two speakers.

Meanwhile, as seen in an illustration (b) in FIG. 9, if a viewing position of the user is out of the rendering technique A effective area 901 (Step S204: NO), the audio signal renderer 104 determines, based on track kind information obtained from the content analyzer 101, whether the input audio image is subjected to sound image localization (Step S205). In this third embodiment, the audio track subjected to sound image localization is an object-based track in the track information 201. If the input audio track is subjected to sound image localization (Step S205: YES), the audio signal renderer 104 reads out from the storage unit 105 a parameter to be required for rendering audio, using a rendering technique B (Step S206). Then, the audio signal renderer 104 further causes the processing to branch, depending on a distance d between the rendering technique A effective area 901 and the current viewing position 906 of the user (Step S208). Specifically, if the distance d between the rendering technique A effective area 901 and the current viewing position 906 of the user is a threshold α or greater (Step S208: YES, and corresponding to a positional relationship between the effective area 901 and the viewing position 908 in the illustration (c) in FIG. 9), the audio signal renderer 104 renders the audio signal using the rendering technique B, based on the previously read out parameter, and outputs the rendered audio signal to the second audio signal output unit 107 (Step S212). The second audio signal output unit 107 in this third embodiment is open-type headphones or earphones wearable by the user as illustrated in FIG. 9. The rendering technique B involves binaural processing, using these open-type headphones or earphones. Moreover, the threshold α is any given real value previously set for the audio signal processing device. Meanwhile, if the distance d is smaller than the threshold α (Step S208: NO, and corresponding to a positional relationship between an area (a predetermined area) 902 indicating the distance d smaller than threshold α and the viewing position 907 in the illustration (b) in FIG. 9), the audio signal renderer 104 additionally reads out from the storage unit 105 a parameter to be required for the rendering technique A (Step S213), and renders the audio signal with the a rendering technique D. The rendering technique D in this third embodiment involves a mixed application of the rendering techniques A and B. The rendering technique D involves rendering by multiplying by a coefficient p1 a result of calculating the input audio track with the rendering technique A, and outputting the rendering result to the first audio signal output unit 106. Moreover, the rendering technique D involves rendering by multiplying by a coefficient p2 a result of calculating the input audio track with the rendering technique B. and outputting the rendering result to the second audio signal output unit 107. Here, the coefficients p1 and p2 vary depending on the distance d, and represented, for example, as follows:

p1=d/α

p2=1−p1

Finally, if the input audio track is not subjected to sound image localization (Step S205: NO), the audio signal renderer 104 reads out from the storage unit 105 a parameter to be required for rendering an audio signal, using a rendering technique C (Step S207). Then, the audio signal renderer 104 further causes the processing to branch, depending on the distance d between the rendering technique A effective area 901 and the current viewing position 906 of the user (Step S209). If the distance d is the threshold α or greater as seen in the illustration (c) of FIG. 9 (Step S209: YES), the audio signal renderer 104 renders the audio signal using the rendering technique C, based on the previously read out parameter, and outputs the rendered audio signal to the first audio signal output unit 106 (Step S216). As described before, the first audio signal output unit 106 in this third embodiment includes the two speakers; namely, the speakers 903 and 904 placed in front of the user. The rendering technique C involves down-mixing the audio signal to stereo audio. When outputting the stereo audio, the two speakers 903 and 904 included in the first audio signal output unit 106 function as a pair of stereo speakers. Meanwhile, as to the position of the viewer, if the distance d is smaller than the threshold α as seen in the illustration (b) in FIG. 9 (Step S209: NO), the audio signal renderer 104 additionally reads out from the storage unit 105 a parameter to be required for the rendering technique A (Step S215), and renders the audio signal with a rendering technique E. The rendering technique E in this third embodiment involves a mixed application of the rendering techniques A and C. The rendering technique E involves (i) rendering by multiplying by the coefficient p1 a result of calculating the input audio track with the rendering technique A. (ii) rendering by multiplying by the coefficient p2 a result of calculating the input audio track with the rendering technique B, (iii) adding the results of the renderings, and (iv) outputting the added rendering result to the first audio signal output unit 106. The same goes for the coefficients p1 and p2.

Applying the processing to all the audio tracks, the audio signal renderer 104 switches a rendering technique, depending on the position of the viewer; that is, whether the user is positioned in an effective area capable of providing the user with an advantageous effect of the rendering technique A. Such features make it possible not only to offer the user a sound field which can provide both a localized sound image and spreading sound no matter where the user is positioned, but also to reduce a sudden change in sound quality due to the change of the rendering technique near the border of an effective area in which the rendering technique changes.

Note that, as described in the first embodiment, an audio track can be processed for any given processing time of unit, and the rendering techniques A to E described above are examples. Such features are also applicable to this third embodiment.

### Fourth Embodiment

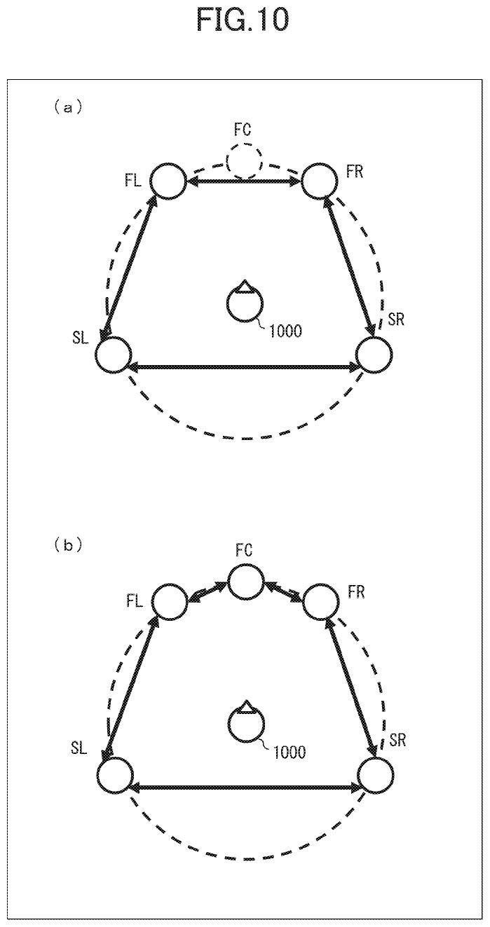

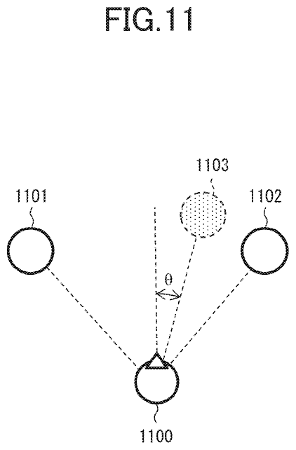

Described below is still another embodiment of the audio signal processing system according to an aspect of the present invention, with reference to FIGS. 10 and 11. Note that, for the sake of explanation, identical reference signs are used to denote components with identical functions between the first embodiment and this embodiment. Such components will not be elaborated upon here.

The first embodiment is described on the condition that audio content to be received by the content analyzer 101 includes both of the channel-based and object-based tracks. Moreover, the first embodiment is described on the condition that the channel-based track does not include an audio signal subjected to sound image localization. Described in the fourth embodiment is an operation of the content analyzer 101 when the audio content includes the channel-based track alone, and the channel-based track includes an audio signal subjected to sound image localization. Note that the difference between the first embodiment and the fourth embodiment is the operation of the content analyzer 101 alone. The operations of other components have already been described, and the detailed description thereof shall be omitted.

For example, when the content analyzer 101 receives 5.1-channel content, a technique disclosed in Patent Document 2; that is, a sound image localization calculating technique based on information on a correlation between two channels, is applied to create a similar histogram in accordance with the sequence below. As to the channels other than a low frequency effect (LFE) included in the 5.1-ch audio, the correlation between the neighboring channels is calculated. The illustration (a) in FIG. 10 shows that, in a 5.1-ch audio signal, pairs of the neighboring channels include four pairs; namely, FR and FL, FR and SR. FL and SL, and SL and SR. (Note that a reference numeral 1000 in FIG. 11 denotes a position of the viewer.) In this case, calculation of the correlation information on neighboring channels involves calculating a correlation coefficient d(i) of f frequency bands quantized in any given manner for an unit time n, and, based on the correlation coefficient d(i), calculating a sound image localization position θ for each of the f frequency bands (Math. 12 of Patent Document 2). For example, as illustrated in FIG. 11, a sound image localization position 1103 based on the correlation between an FL1101 and an FR1102 is represented as θ based on the center of an angle formed between the FL1101 and the FR1102. (Note that a reference numeral 1100 in FIG. 11 denotes a position of the viewer.) In the fourth embodiment, each of the sounds of the quantified f frequency bands is to be a different audio track. Moreover, the audio tracks are classified as follows: in an unit time of a sound of each frequency band, a time period having the correlation coefficient d(i) of a predetermined threshold Th_d or greater is determined as an object-based track, and a time period other than the previously stated time period is determined as a channel-based track. That is, the audio tracks are classified as 2*N*f audio tracks where N is the number of pairs of neighboring channels whose correlation is calculated, and f is the number of frequency bands to be quantified.

Moreover, as described above, θ to be obtained as the sound image localization position is based on the center between the positions of the sound sources. Hence, θ is to be appropriately converted into the coordinate system illustrated in FIG. 3.

The above processing is also performed on the pairs other than FL and FR, and a pair of an audio track and track information 201 corresponding to the audio track is to be sent to the audio signal renderer 104.

In the above description, as disclosed in Patent Document 2, an FC channel to which dialogue audio is mainly assigned is not subject to the correlation calculation since not many sound pressure controls to create a sound image are provided between the FC channel and the FL and FR channels. Instead, the above description is to discuss a correlation between FL and FR. Note that, as a matter of course, the histogram may be calculated, taking a correlation including FC into consideration. For example, as illustrated in the illustration (b) in FIG. 10, the track information may be generated by the above calculation technique for correlations of five pairs; namely, FC and FR. FC and FL. FR and SR. FL and SL, and SL and SR.

As can be seen, the above features make it possible to offer the user well-localized audio, in accordance with an arrangement of the speakers which the user makes, or by analyzing details of channel-based audio provided as an input, even if the audio content includes a channel-based track alone and the channel-based track includes an audio signal subjected to sound image localization.

### Fifth Embodiment

Described below is still another embodiment of the audio signal processing system according to an aspect of the present invention. Note that, for the sake of explanation, identical reference signs are used to denote components with identical functions between the first embodiment and this embodiment. Such components will not be elaborated upon here.

A fifth embodiment is different in a flow of rendering from the above first embodiment.

In the above first embodiment, when the audio signal renderer 104 starts processing (FIG. 1), the audio signal renderer 104 obtains viewing position information on a user, and determines whether the user is within the rendering technique A effective area 401 (FIG. 4) as the basis.

Whereas, when the audio signal renderer 104 (FIG. 1) starts processing in this fifth embodiment, the audio signal renderer 104 determines whether an audio track input is subjected to sound image localization, based on track kind information included in sounding object position information obtained from the content analyzer 101.

Next, if the input audio track is subjected to sound image localization, the audio signal renderer 104 reads out from the storage unit 105 a parameter to be required for rendering an audio signal, using the rendering technique B. Then, the audio signal renderer 104 renders the audio signal using the rendering technique B. and outputs the rendered audio signal to the second audio signal output unit 107 (FIG. 5). As seen in the first embodiment, the second audio signal output unit 107 in the fifth embodiment is open-type headphones or earphones. The rendering technique B involves binaural processing, using these open-type headphones or earphones. Note that, in this case, the first audio signal output unit 106 (the two speakers 402 and 403 in FIG. 5) does not output audio.

Meanwhile, if the input audio track is not subjected to sound image localization, the audio signal renderer 104 reads out from the storage unit 105 a parameter to be required for rendering an audio signal, using the rendering technique C. Then, the audio signal renderer 104 renders the audio signal using the rendering technique C, and outputs the rendered audio signal to the first audio signal output unit 106. As described before, the first audio signal output unit 106 (FIG. 5) in this fifth embodiment includes the two speakers; namely, the speakers 402 and 403 placed in front of the user. The rendering technique C involves down-mixing the audio signal to stereo audio. When outputting the stereo audio, the two speakers 402 and 403 (FIG. 5) function as a pair of stereo speakers. Note that, in this case, the second audio signal output unit 107 (FIG. 5) does not output audio.

That is, this fifth embodiment determines which audio output unit to be used, either an audio output unit a sweet spot of which is to move while the user is listening to audio or an audio output unit a sweet spot of which is not to move while the user is listening to audio, depending on whether the audio track is subjected to sound image localization. More specifically, if the audio track is determined to be subjected to sound image localization, the audio is output from the audio output unit the sweet spot of which is to move while the user is listening to the audio. Moreover, if the audio track is determined not to be subjected to sound image localization, the audio is output from the audio output unit the sweet spot of which is not to move while the user is listening to the audio.

In this embodiment, a preferred rendering technique in view of both sound localization and spreading sound is automatically selected for each of the audio tracks, and the audio is reproduced. Such features make it possible to provide the user with audio having less problems in sound localization and spreading sound no matter where the viewer is positioned.

### Sixth Embodiment

Described below is still another embodiment of the audio signal processing system according to an aspect of the present invention. Note that, for the sake of explanation, identical reference signs are used to denote components with identical functions between the first embodiment and this embodiment. Such components will not be elaborated upon here.

A sixth embodiment is different in the second audio signal output unit 107 from the above first embodiment. Specifically, both of the first and sixth embodiments have a feature in common; that is, the second audio signal output unit 107 is an audio signal output unit a sweet spot of which is to move while the user is listening to the audio. However, the second audio signal output unit 107 of this sixth embodiment is not a wearable audio signal output unit, but a stationary speaker in a fixed position capable of changing its directivity.

In this sixth embodiment, no audio signal output unit is wearable. Hence, the viewer position information obtainment unit 102 (FIG. 1) uses a camera described above to obtain position information on a user.

As a processing flow for rendering, the one described above may be adopted.

### Seventh Embodiment

Described below is still another embodiment of the audio signal processing system according to an aspect of the present invention. Note that, for the sake of explanation, identical reference signs are used to denote components with identical functions between the first embodiment and this embodiment. Such components will not be elaborated upon here.

The first embodiment elaborates a user's position alone. However, the present invention is not limited to the use's position. The sixth embodiment may elaborate the user's position and orientation to localize a sound image.

The orientation of the user can be detected, for example, with a gyro sensor mounted on the second audio signal output unit 107 (FIG. 5) that the user wears.

Then, information indicating the detected orientation of the user is output to the audio signal renderer 104. When performing rendering, the audio signal renderer 104 uses this information indicating the orientation, in addition to the aspect of the first embodiment, to localize the image in accordance with the orientation of the user.

### Eighth Embodiment

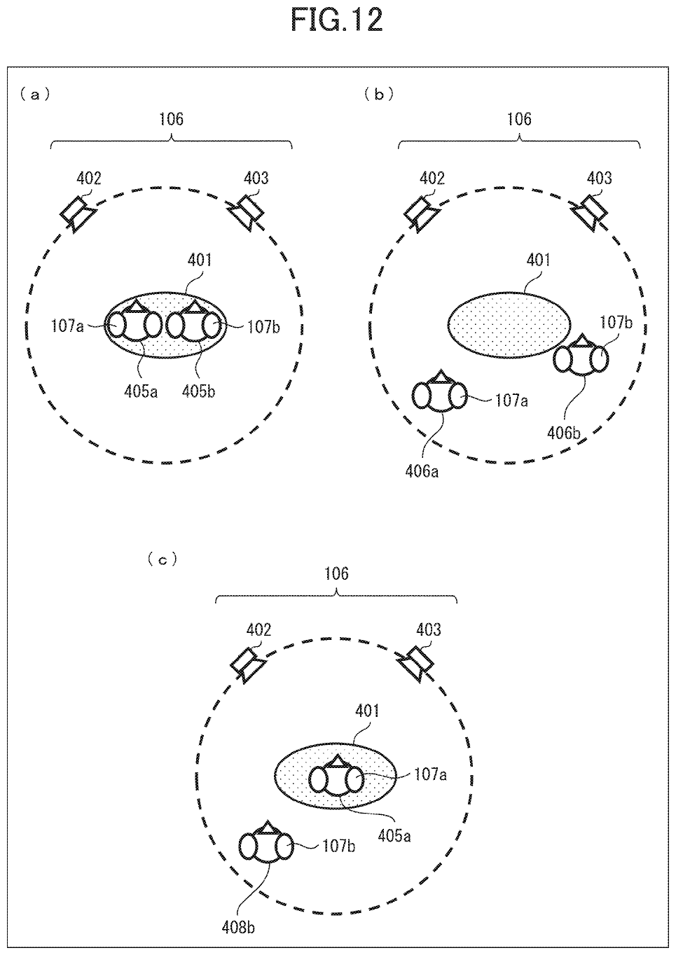

Described below is still another embodiment of the audio signal processing system according to an aspect of the present invention, with reference to FIG. 12. Note that, for the sake of explanation, identical reference signs are used to denote components with identical functions between the first embodiment and this embodiment. Such components will not be elaborated upon here.

The difference between the first embodiment and this eighth embodiment is as follows. In this eighth embodiment, two or more users are found; namely, a first viewer within the rendering technique A effective area 401 and a second viewer out of the rendering technique A effective area 401. The second viewer hears audio output only from the second audio signal output unit 107 worn by the second viewer; whereas, the second viewer cannot hear or is less likely to hear audio output from the first audio signal output unit 106 that is stationary. Specifically, the second audio signal output unit 107 worn by this second viewer is additionally capable of canceling audio to be output from the first audio signal output unit 106.

This eighth embodiment is described below. Described first is a case in which two users are found under a content viewing environment.

FIG. 12, corresponding to FIG. 5 in the first embodiment, is a top view schematically illustrating positions of the users in the eighth embodiment.

As seen in the rendering processing flow illustrated in FIG. 4 of the above first embodiment, the audio signal renderer 104 starts processing (Step S101). First, the audio signal renderer 104 obtains from the storage unit 105 an area capable of providing an advantageous effect of the audio signal to be output with a basic rendering technique (hereinafter referred to as “rendering technique A”); that is, a rendering technique A effective area 401 (also referred to as a sweet spot) (Step S102).

Moreover, the audio signal renderer 104 obtains viewer position information on the first and second viewers from the viewer position information obtainment unit 102.

As seen in the illustration (a) in FIG. 12, if both a viewing position 405a of the first viewer and a viewing position 405b of the second viewer are within the rendering technique A effective area 401, the audio signal renderer 104 reads out from the storage unit 105 a parameter to be required for rendering an audio signal, using the rendering technique A (Step S106). Then, the audio signal renderer 104 renders the audio signal using the rendering technique A. and outputs the rendered audio signal to the first audio signal output unit 106 (Step S107). Note that, as described in the first embodiment, the first audio signal output unit 106 in this eight embodiment includes stationary speakers. As seen in the illustration (a) in FIG. 12, the first audio signal output unit 106 includes two speakers; namely, the speaker 402 and the speaker 403 placed in front of the users. Specifically, the rendering technique A involves transaural processing using these two speakers. Note that, in this case, a second audio signal output unit 107a in the viewing position 405a of the first viewer does not output audio, neither does a second audio signal output unit 107b in the viewing position 405b of the second viewer.

Meanwhile, if both the viewing position 406a of the first viewer and the viewing position 406b of the second viewer are out of the rendering technique A effective area 401 (Step S104: NO), based on track kind information included in sounding object position information obtained from the content analyzer 101, the audio signal renderer 104 determines whether the input image is subjected to sound image localization (Step S105). In this eighth embodiment, the audio track subjected to sound image localization is the object-based track in the track information 201 in FIG. 2. If the input audio track is subjected to sound image localization (Step S105: YES), the audio signal renderer 104 reads out from the storage unit 105 a parameter to be required for rendering an audio signal, using the rendering technique B (Step S108). Then, the audio signal renderer 104 renders the audio signal using the rendering technique B, and outputs the rendered audio signal to the second audio signal output unit 107a in the viewing position 406a of the first viewer and to the second audio signal output unit 107b in the viewing position 406b of the second viewer (Step S109). Similar to the second audio signal output unit 107 described before, the second audio signal output units 107a and 107b are open-type headphones or earphones. The rendering technique B involves binaural processing, using these open-type headphones or earphones. In this eighth embodiment, a different audio signal is output to the second audio signal output unit 107a in the viewing position 406a of the first viewer and the second audio signal output unit 107b in the viewing position 406b of the second viewer. Such a feature makes it possible to appropriately localize a sound image when the viewers hear audio in their respective viewing positions. Note that, in this case, the first audio signal output unit 106 (the two speakers 402 and 403) does not output audio.

On the other hand, if the input audio track is not subjected to sound image localization (Step S105: NO), the audio signal renderer 104 reads out from the storage unit 105 a parameter to be required for rendering an audio signal, using the rendering technique C (Step S110). Then, the audio signal renderer 104 renders the audio signal using the rendering technique C. and outputs the rendered audio signal to the first audio signal output unit 106 (Step S111). As described above, the first audio signal output unit 106 in this first embodiment is the two speakers 402 and 403 placed in front of the users. The rendering technique C involves down-mixing the audio signal to stereo audio. When outputting the stereo audio, the two speakers 402 and 403 included in the first audio signal output unit 106 function as a pair of stereo speakers. Note that, in this case, the second audio signal output unit 107a in the viewing position 407a of the first viewer does not output audio, neither does the second audio signal output unit 107b in the viewing position 407b of the second viewer.

Described next as an aspect of this eight embodiment is a case where the following fact is found out from viewing position information on the users obtained from the viewer position information obtainment unit 102; that is, a viewing position 408a of the first viewer is within the rendering technique A effective area 401; whereas a viewing position 408b of the second viewer is out of the rendering technique A effective area 401.

In this case, in the viewing position 408a of the first viewer within the rendering technique A effective area 401, an audio signal rendered using the rendering technique A is output from the first audio signal output unit 106 (the two speakers 402 and 403). In this case, the second audio signal output unit 107a in the viewing position 408a of the first viewer does not output audio.

Meanwhile, in the viewing position 408b of the second viewer out of the rendering technique A effective area 401, the audio signal renderer 104 renders the audio signal using the rendering technique B, and outputs the rendered audio signal to the second audio signal output unit 107b in the viewing position 408b of the second viewer. In this case, the first audio signal output unit 106 (the two speakers 402 and 403) outputs an audio signal rendered using the rendering technique A. Hence, the second viewer wearing the second audio signal output unit 107b that is open-type headphones or earphones and staying in the viewing position 408b hears audio output from the first audio signal output unit 106 (the two speakers 402 and 403) in addition to audio output from the second audio signal output unit 107b and having an sound image localized. However, the audio to be output from the first audio signal output unit 106 (the two speakers 402 and 403) has a sound image to be localized within the rendering technique A effective area 401. Hence, it is difficult to offer a high-quality sound field in the viewing position 408b out of the effective area 401.

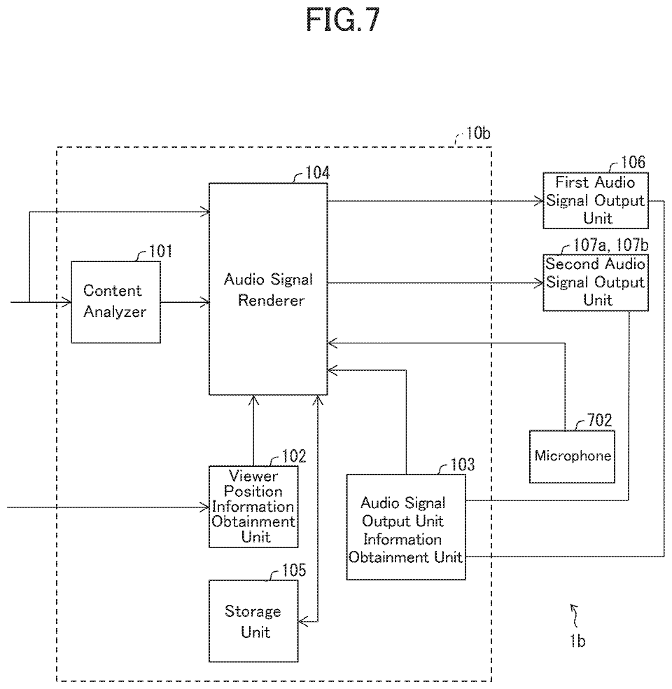

Thus, in this eighth embodiment, the second audio signal output unit 107b is capable of canceling the audio output from the first audio signal output unit 106 (the two speakers 402 and 403). Specifically, as illustrated in FIG. 7, a microphone 702 is connected to the audio signal renderer 104, and measures an audio signal. The second audio signal output unit 107b outputs an audio signal reversed in phase from the measured audio signal, and cancels the audio output from the first audio signal output unit 106. Here, the microphone 702 includes one or more microphones. Preferably, one microphone is provided close to the auricle for each of the right and left ears of the viewer. If the second audio signal output unit 107b is earphones or headphones, the earphones or headphones may be provided close to the auricles of the ears as a component of the second audio signal output unit 107b.

Hence, the wearer of the second audio signal output unit 107b (the second viewer) hears only the audio output from the second audio signal output unit 107b and subjected to sound image localization. Such a feature makes it possible to offer a high-quality sound field not only to the first viewer within the rendering technique A effective area 401 but also to the second viewer in the viewing position 408b out of the effective area 401.

### Ninth Embodiment

Described below is still another embodiment of the audio signal processing system according to an aspect of the present invention. Note that, for the sake of explanation, identical reference signs are used to denote components with identical functions between the eighth embodiment and this embodiment. Such components will not be elaborated upon here.

The difference between the eighth embodiment and this ninth embodiment is that, in the ninth embodiment, even though viewing positions of two viewers are within the rendering technique A effective area 401, the audio to be heard by one of the viewers (the second viewer) is rendered with the rendering technique B to be output from the second audio signal output unit 107 worn by the second viewer.

As seen in the illustration (a) in FIG. 12, both the viewing position 405a of the first viewer and the viewing position 405b of the second viewer are within the rendering technique A effective area 401. In this case, audio rendering with the rendering technique A is performed in the viewing position 405a of the first viewer, and the audio is output from the first audio signal output unit 106. Meanwhile, audio rendering with the rendering technique B is performed in the viewing position 405b of the second viewer, and the audio is output from the second audio signal output unit 107b in the viewing position 405b of the second viewer.

As described in the eighth embodiment, the ninth embodiment can also achieve cancellation of audio, output from the first audio signal output unit 106, by the second audio signal output unit 107b.

### Tenth Embodiment

Described below is still another embodiment of the audio signal processing system according to an aspect of the present invention. Note that, for the sake of explanation, identical reference signs are used to denote components with identical functions between the first embodiment and this embodiment. Such components will not be elaborated upon here.

The difference between the first embodiment and this tenth embodiment is that, in the first embodiment, the user within the effective area 401 of FIG. 4 is to hear audio output from the first audio signal output unit 106 that is a stationary speaker; whereas, in the tenth embodiment, the user within the effective area 401 of FIG. 4 is provided with an audio signal not subjected to sound image localization from the first audio signal output unit 106 that is a stationary speaker, and with an audio signal subjected to sound image localization from open-type headphones or earphones (the second audio signal output unit 107) worn by the user.

Such features allow the user within the effective area 401 of FIG. 4 to hear audio from both the first audio signal output unit 106 and the second audio signal output unit 107.

Even if two or more users are found within the effective area 401 of FIG. 4, the tenth embodiment beneficially makes it possible to adjust sound quality for each of the users.

### SUMMARY

An audio signal processing device (the audio signal processor 10) according to a first aspect of the present invention is an audio signal processing device for multiple channels. The device includes: a sound image localization information obtainment unit (the audio signal renderer 104) obtaining information indicating whether an audio signal input is subjected to sound image localization; and a renderer (the audio signal renderer 104) rendering the audio signal input, and outputting the rendered audio signal to one or more audio signal output units based on the information, the one or more audio signal output units including a first audio signal output unit (the first audio signal output unit 106 and the speakers 402 and 403) an audible region of which does not move while a user is listening to audio and a second audio signal output unit (the second audio signal output units 107, 107a, and 107b) an audible region of which moves while the user is listening to the audio.

The above features can offer a high-quality sound field to a user.

Here, the second audio signal output unit an audible region of which can move while the user is listening to the audio is capable of allowing a so-called sweet spot to move depending on the position of the user. Meanwhile, the first audio signal output unit an audible region of which does not move while the user is listening to the audio does not allow the sweet spot to move depending on the position of the user.

If the input audio signal is subjected to sound image localization, the above features make it possible to render the audio signal, using a rendering technique to cause the second audio signal output unit to output the audio signal. Here, the second audio signal output unit allows the sweet spot to move depending on the position of the user. Meanwhile, if the input audio signal is not subjected to sound image localization, the above features make it possible to render the audio signal, using a rendering technique to cause the first audio signal output unit to output the audio signal. Here, the first audio signal output unit does not allow the sweet spot to move depending on the position of the user.

An audio signal processing device (the audio signal processor 10) according to a second aspect of the present invention is an audio signal processing device for multiple channels. The device includes: a position information obtainment unit (the viewer position information obtainment unit 102) obtaining position information on a user; and; and a renderer (the audio signal renderer 104) rendering an audio signal input, and outputting the rendered audio signal to one or more audio signal output units based on the information, the one or more audio signal output units including a first audio signal output unit (the first audio signal output unit 106 and the speakers 402 and 403) an audible region of which does not move while a user is listening to audio and a second audio signal output unit (the second audio signal output units 107, 107a, and 107b) an audible region of which moves while the user is listening to the audio.

The above features can offer a high-quality sound field to a user.

The above features make it possible to render an audio signal, depending whether a user is positioned within a sweet spot corresponding to a rendering technique. For example, if the user is positioned within the sweet spot, the features make it possible to render the audio signal using a rendering technique causing the first audio signal output unit to output the audio signal. Here, the first audio signal output unit does not allow the sweet spot to move depending on the position of the user. Meanwhile, if the user is positioned out of the sweet spot, the features make it possible to render the audio signal using a rendering technique causing the second audio signal output unit to output the audio signal. Here, the second audio signal output unit allows the sweet spot to move depending on the position of the user. Such features make it possible to offer a high-quality sound field even if the user is in any given listening position.

The device (the audio signal processor 10) of a third aspect of the present invention according to the first or second aspect may further include: an analyzer (the content analyzer 101) analyzing the audio signal input to obtain a kind of the audio signal and position information on localization of the audio signal; and the storage unit 105 storing a parameter to be required for the renderer.

In the device (the audio signal processor 10) of a fourth aspect of the present invention according to any one of the first to third aspects, the first audio signal output unit may be a stationary speaker (the first audio signal output unit 106 and the speakers 402 and 403), and the second audio signal output unit may be a portable speaker for the user (the second audio signal output units 107, 107a, and 107b).

In the device (the audio signal processor 10) of a fifth aspect of the present invention according to any one of the first to third aspects, the second audio signal output unit (the second audio signal output units 107, 107a, and 107b) may be (i) open-type headphones or earphones. (ii) a speaker movable depending on a position of the user, or (iii) a stationary speaker capable of changing directivity.

The device (the audio signal processor 10) of a sixth aspect of the present invention according to any one of the first to fifth aspects may further include the audio signal output unit information obtainment unit 103 obtaining information indicating the first audio signal output unit and the second audio signal output unit.

The above features make it possible to select a rendering technique suitable to a kind of an obtained audio signal output unit.

In the device (the audio signal processor 10) of a seventh aspect of the present invention according to the sixth aspect, the audio signal output unit information obtainment unit 103 may obtain the information indicating the first audio signal output unit from the first audio signal output unit, and the information indicating the second audio signal output unit from the second audio signal output unit.

In the device (the audio signal processor 10) of an eight aspect of the present invention according to the sixth aspect, the audio signal output unit information obtainment unit 103 may select, from the information previously stored and indicating the first audio signal output unit (the first audio signal output unit 106 and the speakers 402 and 403) and the second audio signal output unit (the second audio signal output units 107, 107a, and 107b), the information either on the first audio signal output unit or the second audio signal information to be used.

In the device (the audio signal processor 10) of a ninth aspect of the present invention according to the second aspect, the renderer (the audio signal renderer 104) may select a rendering technique to be used for rendering based on whether a position of the user is included in the audible region (the rendering technique A effective area 401) previously set.

In the device (the audio signal processor 10) of a tenth aspect of the present invention according to the second or ninth aspect, if a position of the user is included within a predetermined area (the area 902) from the audible region (the rendering technique A effective area 901) previously set even though the position is not included in the audible region, the renderer (the audio signal rendering unit 104) may render (rendering with the rendering technique D), using a rendering technique (the rendering technique A) to localize a sound image in the audible region and a rendering technique (the rendering technique B) to localize the sound image out of the audible region.

The device (the audio signal processor 10) of an eleventh aspect of the present invention according to any one of the first to tenth aspects may include the first audio signal output unit (the first audio signal output unit 106 and the speakers 402 and 403) and the second audio signal output unit (the second audio signal output units 107, 107a, and 107b).

The device (the audio signal processor 10) of a twelfth aspect of the present invention according to the second aspect may further include an imaging device (a camera) capturing the user, wherein the position information obtainment unit may obtain the position information on the user based on data captured by the imaging device.

The audio signal processing system 1 of a thirteenth aspect of the present invention is an audio signal processing system for multiple channels. The system includes: a first audio signal output unit (the first audio signal output unit 106 and the speakers 402 and 403) an audible region of which does not move while a user is listening to audio and a second audio signal output unit (the second audio signal output units 107, 107a, and 107b) an audible region of which moves while the user is listening to the audio; a sound image localization information obtainment unit (the audio signal renderer 104) obtaining information indicating whether an audio signal input is subjected to sound image localization; and a renderer (the audio signal renderer 104) rendering the audio signal input, and outputting the rendered audio signal to one or more audio signal output units based on the information, the one or more audio signal output units including the first audio signal output unit and the second audio signal output unit.

The audio signal processing system 1 of a fourteenth aspect of the present invention is an audio signal processing system for multiple channels. The system includes: a first audio signal output unit (the first audio signal output unit 106 and the speakers 402 and 403) an audible region of which does not move while a user is listening to audio and a second audio signal output unit (the second audio signal output units 107, 107a, and 107b) an audible region of which moves while the user is listening to the audio; a position information obtainment unit obtaining position information on a user; and a renderer (the audio signal renderer 104) rendering an audio signal input, and outputting the rendered audio signal to one or more audio signal output units based on the information, the one or more audio signal output units including the first audio signal output unit (the first audio signal output unit 106 and the speakers 402 and 403) and the second audio signal output unit (the second audio signal output units 107, 107a, and 107b).

The present invention shall not be limited to the embodiments described above, and can be modified in various manners within the scope of claims. The technical aspects disclosed in different embodiments are to be appropriately combined together to implement an embodiment. Such an embodiment shall be included within the technical scope of the present invention. Moreover, the technical aspects disclosed in each embodiment are combined to achieve a new technical feature.

### CROSS REFERENCE TO RELATED APPLICATION

The present application claims priority to Japanese Patent Application No. 2017-174102, filed Sep. 11, 2017, the contents of which are incorporated herein by reference in its entirety.

### REFERENCE SIGNS LIST

1, 1a Audio Signal Processing System
10, 10a Audio Signal Processor
101 Content Analyzer
102 Viewer Position Information Obtainment Unit
103, 601 Audio Signal Output Unit Information Obtainment Unit
104 Audio Signal Renderer
105 Storage Unit
106 First Audio Signal Output Unit
107, 107a, 107b Second Audio Signal Output Unit
201 Track Information
401,901 Effective Area
402, 403, 903, 904 Speaker
602 Information Input Unit
702 Microphones
902 Area

1. An audio signal processing device for multiple channels, the device comprising:
a sound image localization information obtainment unit configured to obtain information indicating whether an audio signal input is subjected to sound image localization; and
a renderer configured to render the audio signal input, and output the rendered audio signal to one or more audio signal output units based on the information, the one or more audio signal output units including a first audio signal output unit an audible region of which does not move while a user is listening to audio and a second audio signal output unit an audible region of which moves while the user is listening to the audio, the renderer rendering the audio signal using different rendering techniques for the first audio signal output unit and the second audio signal output unit.

2. An audio signal processing device for multiple channels, the device comprising:
a position information obtainment unit configured to obtain position information on a user; and
a renderer configured to render an audio signal input, and output the rendered audio signal to one or more audio signal output units based on the position information, the one or more audio signal output units including a first audio signal output unit an audible region of which does not move while the user is listening to audio and a second audio signal output unit an audible region of which moves while the user is listening to the audio, the renderer rendering the audio signal using different rendering techniques for the first audio signal output unit and the second audio signal output unit.

3. The device according to claim 1, further comprising:
an analyzer configured to analyze the audio signal input to obtain a kind of the audio signal and position information on localization of the audio signal; and
a storage unit configured to store a parameter to be required for the renderer.

4. The device according to claim 1, wherein
the first audio signal output unit is a stationary speaker.
the second audio signal output unit is a portable speaker for the user.

5. The device according to claim 1, wherein
the second audio signal output unit is (i) open-type headphones or earphones, (ii) a speaker movable depending on a position of the user, or (iii) a stationary speaker capable of changing directivity.

6. The device according to claim 1, further comprising
an audio signal output unit information obtainment unit configured to obtain information indicating the first audio signal output unit and the second audio signal output unit.

7. The device according to claim 6, wherein
the audio signal output unit information obtainment unit obtains the information indicating the first audio signal output unit from the first audio signal output unit, and the information indicating the second audio signal output unit from the second audio signal output unit.

8. The device according to claim 6, wherein
the audio signal output unit information obtainment unit selects, from the information previously stored and indicating the first audio signal output unit and the second audio signal output unit, the information either on the first audio signal output unit or the second audio signal information to be used.

9. The device according to claim 2, wherein
the renderer selects a rendering technique to be used for rendering based on whether a position of the user is included in the audible region previously set.

10. The device according to claim 2, wherein
if a position of the user is included within a predetermined area from the audible region previously set even though the position is not included in the audible region, the renderer renders, using a rendering technique to localize a sound image in the audible region and a rendering technique to localize the sound image out of the audible region.

11. The device according to claim 1, comprising
the first audio signal output unit and the second audio signal output unit.

12. The device according to claim 2, further comprising
an imaging device configured to capture the user, wherein
the position information obtainment unit obtains the position information on the user based on data captured by the imaging device.

13. An audio signal processing system for multiple channels, the system comprising:
a first audio signal output unit an audible region of which does not move while a user is listening to audio and a second audio signal output unit an audible region of which moves while the user is listening to the audio;
a sound image localization information obtainment unit configured to obtain information indicating whether an audio signal input is subjected to sound image localization; and
a renderer configured to render the audio signal input, and output the rendered audio signal to one or more audio signal output units based on the information, the one or more audio signal output units including the first audio signal output unit and the second audio signal output unit the renderer rendering the audio signal using different rendering techniques for the first audio signal output unit and the second audio signal output unit.

14. (canceled)
